(19) United States
(12) Patent Application Publication
(10) Pub. No.: US 2022/0275936 A1
(43) Pub. Date: Sep. 1, 2022

(54) COOLING SYSTEM FOR STEEL PRODUCTION SYSTEM

(71) Applicant: Outokumpu Stainless USA. LLC, Calvert, AL (US)

(72) Inventors: Andrew Bissot, Fairhope, AL (US); Dirk Pechacek, Daphne, AL (US); Michael Romine, Daphne, AL (US)

(21) Appl. No.: 17/186,867

(22) Filed: Feb. 26, 2021

(51) Int. Cl. F23J 15/06; F27D 17/00

(52) U.S. Cl. CPC F23J 15/06; F27D 17/004

(57) ABSTRACT

A cooling system is configured to cool exhaust gases exiting a furnace of a steel production system through an exhaust hood, a dropout box, and a hot gas duct of the steel production system. The cooling system includes an inlet configured to receive water from a water pump for cooling the exhaust gases, and an outlet configured to exhaust the water from the cooling system. The cooling system further includes a first water line configured to supply the water to the exhaust hood of the steel production system for cooling the exhaust gas received therein, and a second water line configured to supply the water to the dropout box of the steel production system for cooling the exhaust gas received therein. The cooling system also includes a third water line configured to supply the water to the hot gas duct of the steel production system for cooling the exhaust gas received therein, and each of the first water line, the second water line, and the third water line are operably coupled between the inlet and the outlet of the cooling system. The cooling system also includes a controller configured to control and maintain a defined temperature of the water circulating within the cooling system.

### TECHNICAL FIELD

Example embodiments generally relate to a cooling system for cooling or reducing the temperate of exhaust gases created within a steel production system.

### BACKGROUND

A system used for the production of steel may include several components, such as a furnace and ductwork, that are water cooled in order to extend the operating life of the respective component. In this regard, the components in the system operate under high temperatures and extreme mechanical stress. Thus, in order to extend the operating life of the system, the components may be or have portions that are water-cooled to reduce or prevent thermal, chemical, and mechanical stress of the components.

### BRIEF SUMMARY OF SOME EXAMPLES

The cooling system described herein may be configured to provide water to water-cooled components of a steel production system. In this regard, a furnace of the steel production system produces exhaust gases during operation, and these exhaust gases are exhausted to components of the steel production system such as an exhaust hood, a dropout box, and a hot gas duct. These exhaust gases need to be cooled in order to reduce stress on the steel production system and to allow for the exhaust gases to be filter effectively by filter components of the steel production system. In order to cool exhaust gases produced by a furnace of the steel production system, a cooling system may be configured to supply water for cooling exhaust gases received by components of the steel production system. The cooling system may also be configured to maintain a defined temperature of the water that ensures the efficient and effective cooling of the exhaust gases. The cooling system is designed to also reduce erosion and corrosion that may occur to the components of the steel production system.

Thus example embodiments may provide a cooling system configured to cool exhaust gases exiting a furnace of a steel production system through an exhaust hood, a dropout box, and a hot gas duct of the steel production system. The cooling system may include an inlet configured to receive water from a water system The outlet configured to route the water from the cooling system. The cooling system may further include a first water line configured to supply the water to the exhaust hood of the steel production system for cooling the exhaust gas received therein, and a second water line configured to supply the water to the dropout box of the steel production system for cooling the exhaust gas received therein. The cooling system may also include a third water line configured to supply the water to the hot gas duct of the steel production system for cooling the exhaust gas received therein, and each of the first water line, the second water line, and the third water line may be operably coupled between the inlet and the outlet of the cooling system. The cooling system may also include a controller configured to control flow returning to the water system and maintain a defined temperature of the water circulating within the cooling system.

A further example embodiment may provide a method of cooling exhaust gases received by components of a steel production system. The method may include causing water to circulate within water lines of a cooling system for the steel production system in order to cool the exhaust gases received by the components. The method may also include monitoring operating parameters of the cooling system to ensure a defined temperature of the water circulating within the water lines is achieved. The method may additionally include executing a program to adjust or maintain the operating parameters of the cooling system to achieve the defined temperature.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a block diagram of a steel production system according to an example embodiment;

FIG. 2 illustrates a furnace used in the steel production system according to an example embodiment;

FIG. 3 illustrates a cooling system for cooling exhaust gases in the steel production system according to an example embodiment;

FIG. 4 illustrates a block diagram of a controller of the cooling system according to a an example embodiment; and

FIG. 5 illustrates a method of cooling exhaust gases in the steel production system according to an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true.

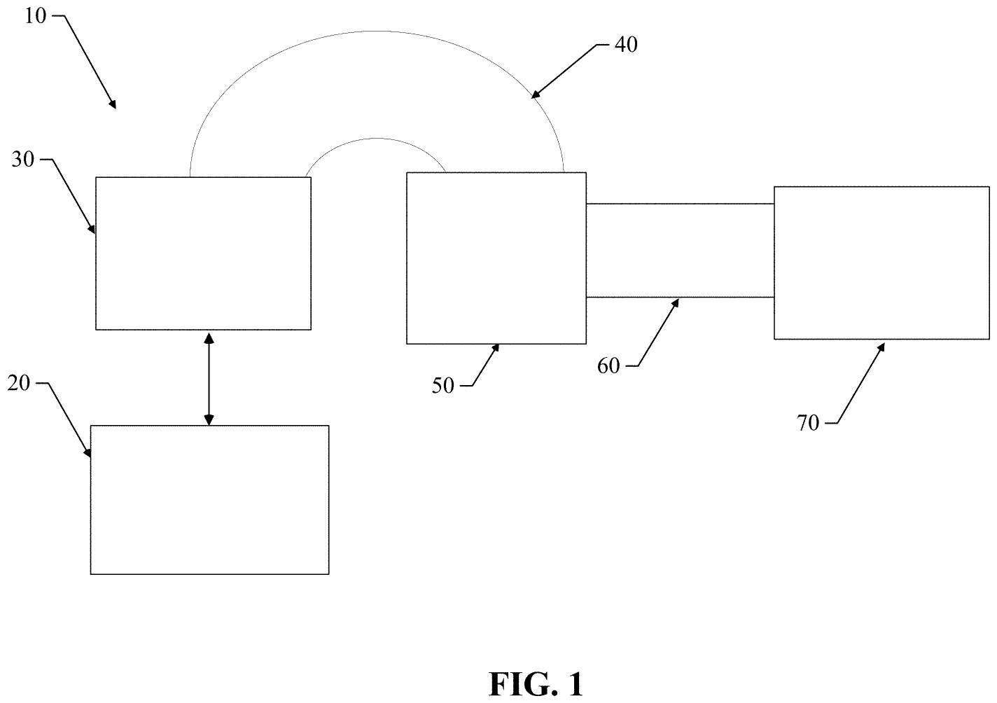

Steel can be made by either refining liquid iron or is produced by melting and refining iron and steel scrap. FIG. 1 illustrates a system 10 used in the production of steel according to an example embodiment. As shown in FIG. 1, the system 10 used in the production of steel includes at least a furnace 20, an exhaust hood 30, an exhaust duct 40, a dropout box 50, an exhaust and hot gas duct 60, and filter components 70. The furnace 20 may be a metallurgical furnace, in which steel is produced by either refining liquid iron or melting the iron and steel scrap. In this case, the metallurgical furnace is an electric arc furnace (EAF). However, in accordance with other example embodiments, the metallurgical furnace may be a basic oxygen furnace or the like.

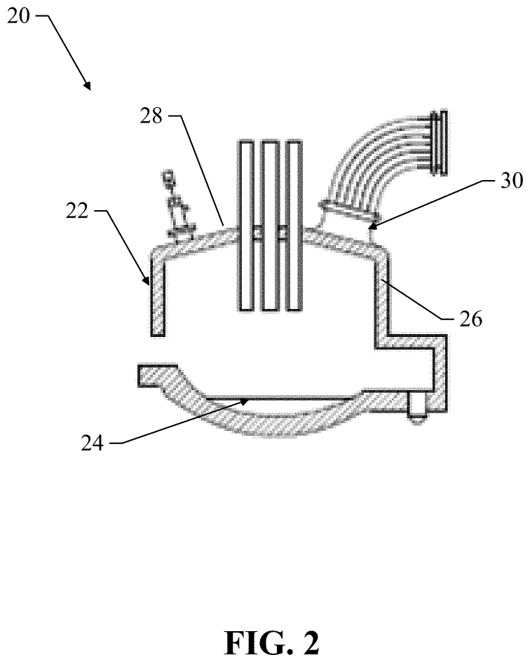

FIG. 2 illustrates the furnace 20 according to an example embodiment. In this regard, the furnace 20 demonstrated in FIG. 2 is an EAF. The furnace 20 may include a shell 22 formed via a smelting area 24, side panels 26, and a roof 28. The furnace 20 may use both electrical and chemical energy to either refining melt iron or melt and refine the iron and steel scrap within the smelting area 24 (i.e., bottom portion) of the shell 22. In order to melt the scrap within the smelting area 24, the furnace 20 typically must maintain a temperature between 800-2000° C. The either refining melt iron or melting and refining of the scrap in the furnace 20 may result in the production of high-temperature exhaust or off-gases which may include particulates and corrosive gases. In this regard, a large volume of exhaust gases may be discharged from the furnace 20 during the melting operation (e.g., via the roof 28), and the exhaust gases may include, for example, carbon dioxide, water vapor, carbon monoxide, hydrogen, or other hydrocarbons and metallic and nonmetallic solid particles or any combination thereof.

As shown in FIGS. 1 and 2, the furnace 20 may be operably coupled to the exhaust hood 30. In this regard, the exhaust hood 30 may be operably coupled to the furnace 20 at the roof 28 of the furnace 20 for exhaust gases. The exhaust hood 30 may control pollution generated via the furnace 20 and capture the off-gases that are created during the process of making steel. Furthermore, as described in more detail below, the exhaust hood 30 may be configured to reduce exhaust or combustion gases to a temperature that is suitable for the filter components 70 (e.g., a baghouse filter) to process. Thus, the exhaust hood 30 may be configured to capture exhaust gases and reduce the exhaust gases from the furnace 20 to a temperature that is manageable for the system 10. Additionally, the system 10 can be managed to control the temperature for subsequent components prior to filter components 70.

As shown in FIGS. 1 and 2, the exhaust hood 30 may include or be operably coupled to duct 40 to the dropout box 50 or hot gas duct 60 or filter components 70. The example embodied is the controlling of gas temperature between the exhaust duct 60 to not compromise the designed intent of filter components 70. Thus, the exhaust gases may travel from the exhaust hood 30 to the dropout box 50 via the exhaust duct 40. The dropout box 50 may be configured to remove large particles (e.g., large dust particles) from the exhaust gases and therefore act as pre-filter before the exhaust gases from the furnace 20 reach the filter components 70. In this regard, the dropout box 50 may be configured to remove larger particles from the exhaust gas stream in order to protect the filter components 70 from abrasion due to a heavy dust load. Simply put, the dropout box 50 may be configured to accumulate any dust contained in the exhaust gases in order to prevent strain on other components of the system 10 such as the filter components 70. The pre-filtered exhaust gases exiting the dropout box 50 may then travel via the hot gas duct 60 to filter components 70 of the system 10. The example embodied can be expanded to have dropout box 50 within multiple examples of exhaust duct 40 or hot duct 60 prior to the gases reaching filter components 70. These filter components 70 may include, for example, a baghouse filter 70. The baghouse filter 70 may include filter bags and fans that are configured to clean the exhaust gases of pollutants.

Due to the high temperature under which the furnace 20 operates and the composition of the exhaust gases from the furnace 20, the furnace 20 and other components of the system 10 (e.g., exhaust hood 30, exhaust duct 40, dropout box 50, and hot gas duct 60) may be subject to thermal, chemical, and mechanical stresses. As mentioned above, the exhaust gases may have a high temperature, include chemical elements, and contain particles. Thus, the exhaust gas from the furnace 20 may lead to corrosion, erosion, and general stress on the components of the system 10. In order to extend the operational life of the furnace 20 and the other components of the system 10 and reduce the stress experienced by the system 10, components of the system 10 may be configured to receive a heat transfer fluid (e.g., water) in order to cool the stream of exhaust gases exiting the furnace and thereof reduce the stress caused by the exhaust gases on the components of the system 10 while not compromising the intent of filter components 70.

In this regard, the furnace 20, the exhaust hood 30, the exhaust duct 40, the dropout box 50, and the hot gas duct 60 may be or include components that are cooled (e.g. water) or a heat transfer fluid. While water is described herein as the medium used for cooling, other heat transfer fluids known in the art of cooling the gasses may also be used in a similar manner as described herein.

Each of the furnace 20, the exhaust hood 30, the exhaust duct 40, the dropout box 50, and the hot gas duct 60 may include or be formed from plates or pipes that are configured to receive water in order to effectively cool the exhaust gases received by the respective component. Thus, the water may flow through the pipes and plates of each of the furnace 20, the exhaust hood 30, the exhaust duct 40, the dropout box 50, and the hot gas duct 60 in order to reduce the temperature of the exhaust gases exiting the furnace 20. For example, the components of the furnace 20 located above the smelting area 24 (i.e., the side panels 26 and the roof 28 of the shell 22) of the furnace 20 may be water cooled by plates or tubes configured to receive cooling water. Similar to the side panels 26 and the roof 28 of the furnace 20, the exhaust hood 30, the exhaust duct 40, the dropout box 50, and the hot gas duct 60 may also include a plurality of plates or tubes to receive and direct the water around the respective component to control the temperature to a design within the system 10.

Notwithstanding that water-cooled components within system 10 have reduced failure caused by the temperature and composition of the exhaust gases leaving the furnace 20, systems for supplying cool water to these cooling plates and tubes are known by one of ordinary skill in the art for being unable to maintain a consistent defined temperature that efficiently and effectively reduces operational stress on the system 10 due to the exhaust gases released from the furnace 20. Furthermore, the exhaust gases have been known by one of ordinary skill in the art to also cause failure of the plates and tubes due to the cooling water received therein being unable to effectively cool the exhaust gases. When the plates or tubes configured to transport the water fail, water may then leak into the component that the plates or tubes are cooling. Furthermore, the plates and tubes downstream in the water circuit, beyond the location of leakage, do not receive the water to the designed criteria. In particular, the variable temperature ranges of the water received via the plates or tubes may lead to problems such as wear, corrosion, and other damage on the plates and tubes themselves.

Accordingly, example embodiments described herein may include a cooling system 100 that is configured to supply cooling water to the system 10 at a defined, maintainable temperature. Water temperatures of known cooling systems typically have a high variability due to, for example, a water pump's distance from the system 10 and the batching of the steel making process. When the water supplied to the system 10 is too cool, condensation can build up on the plates and tubes. The condensation creates acidic conditions, such as sulphuric and chloric acids, beneath dust deposits that adhere to the tubing and plates. Corrosion then gradually attacks the tubing or plates, resulting in tube or plate failures and insertion of water directly into the exhaust gas stream causing safety issues for the system 10. Additionally, when the water is too hot, superheated vapors can form thereby creating a laminar flow on a surface of the plates or tubing and reducing the effectiveness of the cooling capabilities of the respective plates or tubes. Accordingly, the cooling system 100 further described herein reduces the fluctuations in the water temperature of the water supplied to the plates and tubes thereby reducing corrosion and erosion and further extending the operational life of the components of the system 10.

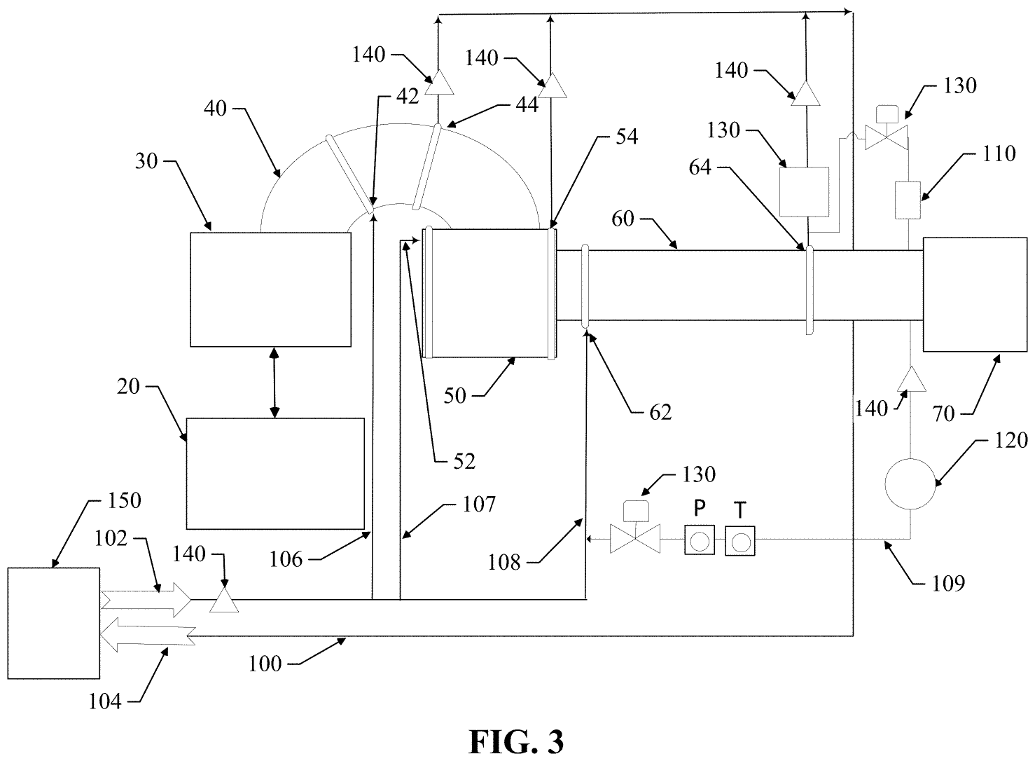

FIG. 3 illustrates an example embodiment of the system 10 having the cooling system 100 operably coupled thereto. The cooling system 100 described herein may include a plurality of water lines, check valves, a flow control valve, and a pump in order to ensure that water circulating within the cooling system 100 maintains a defined temperature that reduces the operational stress on the components of the system 10 and maintains the cooling efficiency of the cooling system 100. In some cases, the cooling system 100 may be configured to maintain a water temperature in the range of approximately 60-70° C. when the system 10 is configured for the production of steel. However, the defined water temperature may be set via an operator of the system 10 based on the composition of what is being processed or produced by the system 10.

As shown in FIG. 3, water may be supplied to the cooling system 100 via a water pump 150 that is located remote from the system 10 and the cooling system 100. The water pump 150 may establish the pressure and flow of water to the cooling system 100 and supply additional water to the cooling system 100 as demanded. In this regard, water from the water pump 150 may enter the cooling system 100 via an inlet 102 for circulation within the cooling system 100. The temperature of the water entering the cooling system 100 via the inlet 102 may have a first defined temperature. For example, the water pump 150 may supply water to the cooling system 100 at an initial temperature of 20-40° C. However, as described herein, the cooling system 100 may be configured to control the temperature of the water received from the water pump 150 independently from the water pump 150. Thus, irrespective of the temperature of the water received directly from the water pump 150, the cooling system 100 may be configured to set, control, and maintain the temperature of the water circulating within the cooling system 100 in order to maximize the operation of the system 10.

As shown in FIG. 3, the water lines of the cooling system 100 may include a exhaust hood water line 106, a dropout box water line 107, and a hot gas duct water line 108. Each of these water lines 106, 107, 108 may be configured to receive water from the water pump 150 via the inlet 102 of the cooling system 100.

The exhaust hood water line 106 may be configured to supply water to the furnace 20, the exhaust hood 30, the exhaust duct 40, or combination thereof in order to effectively and efficiently cool exhaust gases received therein. As shown in FIG. 3, water may be supplied to the exhaust hood water line 106 via an exhaust hood inlet 42. Once the water is received in the exhaust hood inlet 42, the water may circulate within the tubes and plates of the exhaust duct 40 and exit via the exhaust hood outlet 44 to flow toward the outlet 104 of the cooling system 100. The dropout box water line 107 and hot gas duct water line 108 may function similarly to the exhaust hood water line 106. Water may enter the dropout box inlet 52 to circulate within the tubes and plates of the dropout box 50 and then exit via a dropout box outlet 54 to flow toward the outlet 104 of the cooling system 100. Similarly, water may enter a hot gas duct inlet 62 via the hot gas duct water line 108 to circulate within the tubes and plates of the hot gas duct 60 and then exit the hot gas duct outlet 64 and flow toward the outlet 104 of the system 100. Accordingly, water entering the inlet 102 of the cooling system 100 may be supplied to each of the exhaust hood water line 106, the dropout box water line 107, and the hot gas duct water line 108 in order to cool exhaust gases being received by the furnace 20, exhaust hood 30, exhaust duct 40, dropout box 50, and hot gas duct 60.

In some cases, each of the water lines 106, 107, 108 may include one or more check valves disposed therein to allow water flow through a respective water line 106, 107, 108 in one direction and prevent flow from returning in the opposite direction thereby preventing the backflow of water in the cooling system 100 towards inlet 102.

As mentioned above, the cooling system 100 may be configured to maintain the water temperature of the cooling system 100 at defined temperature (e.g., 60-70° C.) suitable for cooling the exhaust gases and reducing or preventing corrosion and erosion of the plates and tubes of each of the components of the system 10. In order to maintain a defined water temperature, the cooling system 100 may also include a recirculating pump 120 and one or more flow control valves 130. The recirculating pump 120 may be located on a pump water line 109. The pump water line 109 may be operably coupled to the hot gas duct water line 109. In this regard, a first end of the pump line 109 may be operably coupled to a portion of the hot gas duct water line 108 located between the inlet 102 of the cooling system 100 and the water inlet 62 of the hot gas duct 60. A second end of the pump line 109 may be operably coupled to a portion of the hot gas duct water line 108 between the outlet 104 of the cooling system 100 and the water outlet 64 of the hot gas duct 60. Under certain circumstances defined herein, the recirculating pump 120 may be configured to recirculate water received from the water lines 106, 107, 108. Similar to water lines 106, 107, 108, the pump line may also include one or more check valves 110. Moreover, it should be appreciated that water may be introduced to other portions of the system 10 as well in alternative embodiments. In this regard, cooling may be provided at any location where acid may be formed as a chemical reaction in the system 10.

The cooling system 100 may also include one or more flow control valves 130. As shown in FIG. 3, one of the flow control valves 130 may be positioned on the hot gas duct water line 108. However, in some cases, one of the flow control valves 130 may be located on the pump line 109 or an additional or second flow control valve 130 may be located on the pump line 109 proximate to pressure (P) and temperature (T) transmitters in order to minimize the amount of water returning to the water pump 150. In certain circumstance as discussed below, the flow control valves 130 may be configured to regulate the flow of water within the cooling system 100 in order to maintain the water at the defined temperature. The flow control valves 130 may be butterfly valves with an actuator, a v-notch ball valve, or any other suitable valve.

Furthermore, the cooling system 100 may include sensors configured to monitor flow rate, temperature, pressure, or any combination thereof of the water in the cooling system 100. In this regard, the sensors may be configured to monitor the operating parameters of the cooling system 100. In this regard, to monitor the water or heat transfer fluid circulating in the cooling system 100, a sensor assembly 140 may be located at a location in the cooling system 100 to monitor one or more of the temperature, the pressure, or the flow rate of the water circulating within the cooling system 100. As shown in FIG. 3, a plurality of sensor assemblies 140 are located in the cooling system 100. For example, each of the water lines 106, 107, 108 may include a sensor assembly 140. In this example embodiment, the sensor assembly 140 located on each water line 106, 107, 108 may be located between the water outlet 44, 54, 64 of the respective component and the outlet 104 of the cooling system 100. Furthermore, in some cases, a sensor assembly 140 may be also located proximate the inlet 102 of the cooling system 100 to detect or verify any of the temperature, pressure, or flow rate of the water entering the cooling system 100. The sensor assemblies 140 may facilitate the monitoring of the temperature of the water or heat transfer fluid to maintain a defined temperature, as discussed above.

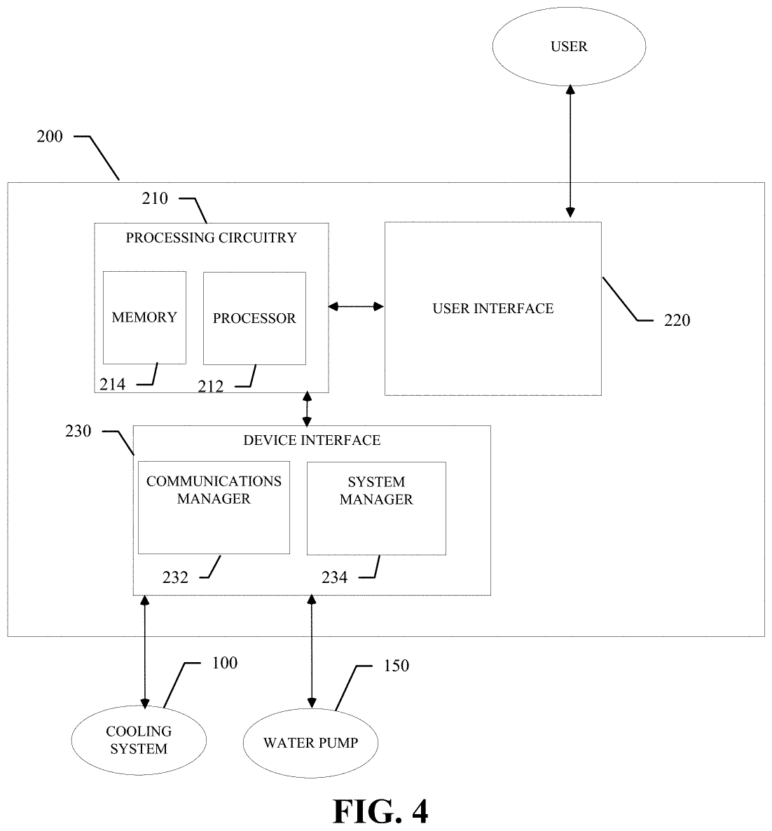

The cooling system 100 may also include a controller 200 configured to monitor operational parameters under which the cooling system 100 is operating. FIG. 4 illustrates a block diagram of the controller 200 of the cooling system 100. Rather than an operator monitoring the conditions under which the cooling system 100 is operating, the controller 200 may be configured to monitor the operating conditions of the cooling system 100 based on data received from the sensor assemblies 140 of the cooling system 100. In other words, the controller 200 may be configured to monitor any of the temperature, flow rate, or pressure of the water at various locations in the cooling system 200 in order to maintain a defined temperature of the cooling system 100 set by the operator. In this regard, the operator of the cooling system 100 may set the defined temperature of the cooling system 100 as desired (e.g., at approximately 60-70° C.) via the controller 200, and the controller 200 may be configured to receive data from any of the sensor assemblies 140 and control the recirculating pump 120 and flow control valves 130 in order to maintain that temperature as further described below.

The controller 200 may include processing circuitry 210 (e.g., a processor 212 and memory 214) configured to store instructions and execute the same in order to control the cooling system 100. In this regard, the processing circuitry 210 to may be configured to process data generated by and relating to the cooling system 100 in conjunction with operating conditions of furnace 20 (e.g., operational parameters or sensor information). In some cases, the processing circuitry 210 may be configured to perform data processing, control function execution, or other processing and management services according to an example embodiment. However, in other examples, the processing circuitry 210 may be configured to manage extraction, storage, or communication of data received at the processing circuitry 210. Thus, for example, the controller 200 may be understood to execute one or more algorithms or programs defining a cooling process of the cooling system 100. The controller 200 may be configured to receive inputs from an operator of the cooling system 100 regarding desired operational parameters of the cooling system 100 (e.g., temperature, pressure, flow rate) in order to provide instructions or controls to the components of the cooling system 100.

In some cases, the controller 200 may include a user interface 220 that allows for the operator of the cooling system 100 to program the desired or defined parameters of the cooling system 100. Thus, the user interface 220 may be in communication with the processing circuitry 210 to receive an indication of a user input at the user interface 220 or to provide an audible, visual, tactile or other output to the user. As such, the user interface 220 may include, for example, a display, one or more switches, lights, buttons or keys (e.g., function buttons), or other input/output mechanisms.

As shown in FIG. 4, the controller 200 may further include the system manager 234 and the communications manager 232. The system manager 234 and the communications manager 232 may be embodied as or otherwise controlled by the processing circuitry 210. However, in some cases, the processing circuitry 210 may be associated with only a specific one of the system manager 234 or the communications manager 232, and a separate instance of processing circuitry may be associated with the other. Yet in some cases, the processing circuitry 210 could be shared between the system manager 234 and the communications manager 232 or the processing circuitry 210 could be configured to instantiate both such entities. Thus, although FIG. 4 illustrates such an instance of sharing the processing circuitry 210 between the system manager 234 and the communications manager 232, it should be appreciated that FIG. 4 is not limiting in that regard.

Each of the system manager 234 and the communications manager 232 may employ or utilize components or circuitry that act as a device interface 230. The device interface 230 may include one or more interface mechanisms for enabling communication with other devices (e.g., the recirculating pump 120, the flow control valve 130). In some cases, the device interface 230 may be any means such as a device or circuitry embodied in either hardware, or a combination of hardware and software that is configured to receive or transmit data from/to components in communication with the processing circuitry 210.

In some embodiments, the system manager 234 may be any means such as a device or circuitry embodied in either hardware, or a combination of hardware and software that is configured to receive or transmit cooling system data (e.g., operational parameters). The system manager 234 may monitor the operational parameters of the cooling system 100 and enable the system manager 234 to implement operational, safeguard, or protective functions as appropriate. These functions may be implemented based upon examination of cooling system data and comparison of such data to various defined thresholds or limits. Thus, the cooling system data may, in some cases, be acted upon locally by the system manager 234.

The system manager 234 may receive the cooling system data (e.g., operation parameters) from the sensor assemblies 140, the flow control valve 130, the recirculating pump 120, or combination thereof. The cooling system data may include, for example, information indicative of temperature, pressure, or flow rate of the water circulating within the cooling system 100 or the status of the flow control valve 130 or the recirculating pump 120 at discrete intervals, continuously, or at discrete times.

Thus, it should be understood that the controller 200 may be configured to receive inputs descriptive of the desired or defined temperature, flow rate, or pressure of the cooling system 100 (e.g., via the user interface 220) in order to provide instructions or controls to the components of the cooling system 100 to effectively control the cooling of the components of the system 10. For example, the controller 200 may be configured to execute various programs in order to ensure that the temperature of the cooling system 100 is maintained at the desired temperature. Accordingly, the controller 200 may execute a cooling program, a heating program, or a maintenance program in order to maintain the defined water temperature of the cooling system 100, or in other words, to facilitate effective cooling of the exhaust gases from the operating conditions of furnace 20. Therefore, the controller 200 may be understood to execute one or more algorithms defining the cooling process for the cooling system 100.

If the controller 200, based on data received from the sensor assemblies 140, determines the temperature of the water within the cooling system 100 needs to be increased in order to achieve or maintain the defined temperature of the cooling system 100, the controller 200 may be configured to run the heating program. In the heating program, the controller 200 may be configured to cause the flow control valve 130 of the cooling system 100 at 108 to fully close and the recirculating pump 120 to become operational. When the flow control valve 130 is closed and the recirculating pump 120 is operational, the water in the cooling system 100 at 108 is prevented from leaving the cooling system 100 via the outlet 104. Rather, the water recirculates causing the temperature of the water to increase. In some cases, the controller 200 may be configured to start the cooling system 100 in the heating program in response to the cooling system 100 initially receiving water from the water pump 150.

Furthermore, based on the operational data or parameters received from the cooling system 100 (e.g., data from the sensor assemblies 140), the controller 200 may determine the temperature of the water needs to be decreased in order to achieve or maintain the defined temperature of the cooling system 100 at 108. Thus, in this case, the controller 200 may be configured to run the cooling program. In the cooling program, the controller 200 may be configured to cause the flow control valve 130 to fully open and also restrict the operation of the recirculating pump 120. In this case, cold water will enter via the inlet 102 from the water pump 150 and hot water will leave by the outlet 104.

Additionally, based on the operational data or parameters received from the cooling system 100 (e.g., data from the sensor assemblies 140), the controller 200 may determine the temperature of the water needs to maintained or held at the defined temperature of the cooling system 100. Thus, in this case, the controller 200 may be configured to run the maintenance program. In the maintenance program, the controller 200 may be configured to cause the flow control valve 130 to partially open and also restrict the operation of the recirculating pump 120. In this case, cold water will gradually enter via the inlet 102 from the water pump 150 and hot water will gradually leave by the outlet 104. In this regard, by controlling the position of the flow control valve 130, the controller 200 is causing the water to more slowly enter and leave the cooling system 100, in contrast to the cooling program where water enters and leaves the cooling system 100 more quickly.

Therefore, it should be understood that the controller 200 may be configured to control the position of the flow control valve 130 or the mode of operation of the recirculating pump 120 if the controller determines that water should leave the cooling system 100 more slowly or quickly. Accordingly, the controller 200 may be configured to monitor the data received from the sensor assemblies 140 in order to ensure that the defined temperature of the water in the cooling system 100 is maintained. Furthermore, it should be understood that the programs executed by the controller 200 mentioned herein are merely exemplary, and the controller 200 may be configured to execute additional programs to control the temperature of the water in the cooling system 100. Specifically, the controller 200 may be configured to control flow rate, pressure, etc. of the water to achieve the defined temperature set by the operator.

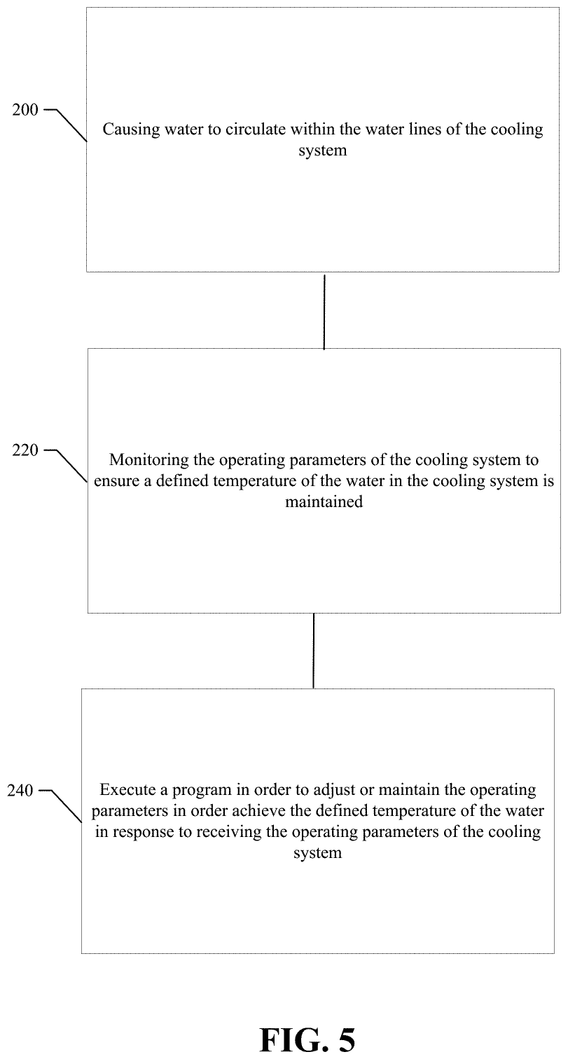

FIG. 5 illustrates a method of cooling exhaust gases received by components of the system 10 using the cooling system 100 described herein. As shown in FIG. 5, the method may include causing water to circulate within the water lines of the cooling system 100, at operation 200. At operation 220, the operating parameters of the cooling system 100 may be monitored to ensure a defined temperature of the water in the cooling system 100 is maintained. At operation 240, in response to receiving the operating parameters from the cooling system 100, the controller is configured to execute a program adjusting or maintaining the operating parameters in order achieve the defined temperature of the water.

Accordingly, example embodiments described herein may provide for a cooling system configured to cool exhaust gases exiting a furnace of a steel production system through an exhaust hood, a dropout box, and a hot gas duct of the steel production system. The cooling system may include an inlet configured to receive water from a water pump for cooling the exhaust gases, and an outlet configured to exhaust the water from the cooling system. The cooling system may further include a first water line configured to supply the water to the exhaust hood of the steel production system for cooling the exhaust gas received therein, and a second water line configured to supply the water to the dropout box of the steel production system for cooling the exhaust gas received therein. The cooling system may also include a third water line configured to supply the water to the hot gas duct of the steel production system for cooling the exhaust gas received therein, and each of the first water line, the second water line, and the third water line may be operably coupled between the inlet and the outlet of the cooling system. The cooling system may also include a controller configured to control and maintain a defined temperature of the water circulating within the cooling system.

The cooling system may include various modifications, additions or augmentations that may optionally be applied. Thus, for example, in some cases, the cooling system may further include a sensor assembly disposed on one of the first water line, the second water line, or the third water line for monitoring the temperature of the water flowing therein, and the controller may be configured to receive temperature data from the sensor assembly in order to control and maintain the defined temperature of the water based on the temperature data. Alternatively or additionally, the sensor assembly may include a first sensor assembly, a second sensor assembly, and a third sensor assembly. The first sensor assembly may be disposed on the first water line, the second sensor assembly may be disposed on the second water line, and the third sensor assembly may be disposed on the third water line. The controller may be configured to receive the temperature data from each of the first sensor assembly, the second sensor assembly, and the third sensor assembly. Alternatively or additionally, the sensor assembly may further include a fourth sensor assembly disposed proximate the inlet of the cooling system, and the controller may be further configured to receive the temperature data of the fourth sensor. Alternatively or additionally, the cooling system may further include a flow control valve and a recirculating pump, and the recirculating pump may be disposed on a pump line of the cooling system. Alternatively or additionally, the flow control valve may be disposed on the hot gas duct line. Alternatively or additionally, the controller may be configured to execute a program in order to control and maintain the defined temperature of the water. Alternatively or additionally, the program may be one of a cooling program, a maintenance program, or a heating program. Alternatively or additionally, the heating program may be executed in response to the temperature of the water circulating within the cooling system being less than the defined temperature. The heating program may include directing the flow control valve to fully close and the recirculating pump to be operational in order to prevent the water leaving the cooling system via the outlet thereby allowing the water within the cooling system to recirculate thereby increasing the temperature of the water to the defined temperature. Alternatively or additionally, the controller may be configured to execute the heating program in response to the water initially entering the cooling system via the inlet upon start-up of the cooling system. Alternatively or additionally, the cooling program may be executed in response to the temperature of the water circulating within the cooling system being hotter than the defined temperature. The cooling program may include directing the flow control valve to fully open and the recirculating pump to stop operation in order to allow the water to leave the cooling system via the outlet and new water from the water pump to enter via the inlet decreasing the temperature of the water to the defined temperature. Alternatively or additionally, the maintenance program may be executed in response to the temperature of the water being at the defined temperature. The maintenance program may include directing the flow control valve to partially close in order to allow the water to gradually leave the cooling system via the outlet and new water from the water pump to gradually enter via the inlet. Alternatively or additionally, the pump line of the cooling system may be operably coupled to the hot gas duct line. Alternatively or additionally, the defined temperature may be set by an operator of the cooling system.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. A cooling system configured to cool exhaust gases exiting a furnace of a steel production system through an exhaust hood, a dropout box, and a hot gas duct of the steel production system, the cooling system comprising:
an inlet configured to receive water from a water pump for cooling the exhaust gases;
an outlet configured to exhaust the water from the cooling system;
a first water line configured to supply the water to the exhaust hood of the steel production system for cooling the exhaust gas received therein;
a second water line configured to supply the water to the dropout box of the steel production system for cooling the exhaust gas received therein;
a third water line configured to supply the water to the hot gas duct of the steel production system for cooling the exhaust gas received therein, wherein each of the first water line, the second water line, and the third water line are operably coupled between the inlet and the outlet of the cooling system; and
a controller configured to control and maintain a defined temperature of the water circulating within the cooling system.

2. The cooling system of claim 1, wherein the cooling system further comprises a sensor assembly disposed on one of the first water line, the second water line, or the third water line for monitoring the temperature of the water flowing therein, wherein the controller is configured to receive temperature data from the sensor assembly in order to control and maintain the defined temperature of the water based on the temperature data.

3. The cooling system of claim 2, wherein the sensor assembly comprises a first sensor assembly, a second sensor assembly, and a third sensor assembly, wherein the first sensor assembly is disposed on the first water line, wherein the second sensor assembly is disposed on the second water line, wherein the third sensor assembly is disposed on the third water line, and wherein the controller is configured to receive the temperature data from each of the first sensor assembly, the second sensor assembly, and the third sensor assembly.

4. The cooling system of claim 3, wherein the sensor assembly further comprises a fourth sensor assembly disposed proximate the inlet of the cooling system, and wherein the controller is further configured to receive the temperature data of the fourth sensor.

5. The cooling system of claim 2, wherein the cooling system further comprises a flow control valve and a recirculating pump, wherein the recirculating pump is disposed on a pump line of the cooling system.

6. The cooling system of claim 5, wherein the flow control valve is disposed on the hot gas duct line.

7. The cooling system of claim 6, wherein the controller is configured to execute a program in order to control and maintain the defined temperature of the water.

8. The cooling system of claim 7, wherein the program is one of a cooling program, a maintenance program, or a heating program.

9. The cooling system of claim 8, wherein the heating program is executed in response to the temperature of the water circulating within the cooling system being less than the defined temperature, and wherein the heating program comprises directing the flow control valve to fully close and the recirculating pump to be operational in order to prevent the water leaving the cooling system via the outlet thereby allowing the water within the cooling system to recirculate thereby increasing the temperature of the water to the defined temperature.

10. The cooling system of claim 9, wherein the controller is further configured to execute the heating program in response to the water initially entering the cooling system via the inlet upon start-up of the cooling system.

11. The cooling system of claim 8, wherein the cooling program is executed in response to the temperature of the water circulating within the cooling system being hotter than the defined temperature, and wherein the cooling program comprises directing the flow control valve to fully open and the recirculating pump to stop operation in order to allow the water to leave the cooling system via the outlet and new water from the water pump to enter via the inlet decreasing the temperature of the water to the defined temperature.

12. The cooling system of claim 8, wherein the maintenance program is executed in response to the temperature of the water being at the defined temperature, and wherein the maintenance program comprises directing the flow control valve to partially close in order to allow the water to gradually leave the cooling system via the outlet and new water from the water pump to gradually enter via the inlet.

13. The cooling system of claim 5, wherein the pump line of the cooling system is operably coupled to the hot gas duct line.

14. The cooling system of claim 1, wherein the defined temperature is set by an operator of the cooling system.

15. A method of cooling exhaust gases received by components of a steel production system, the method comprising:
causing water to circulate within water lines of a cooling system for the steel production system in order to cool the exhaust gases received by the components;
monitoring operating parameters of the cooling system to ensure a defined temperature of the water circulating within the water lines is achieved; and
executing a program to adjust or maintain the operating parameters of the cooling system to achieve the defined temperature.

16. The method of claim 15, wherein the program is one of a cooling program, a maintenance program, or a heating program.

17. The method of claim 16, wherein the method further comprises executing the heating program in response to the temperature of the water circulating within the water lines being less than the defined temperature, wherein the heating program comprises directing a flow control valve of the cooling system to fully close and a recirculating pump of the cooling system to be operational in order to prevent the water leaving the cooling system via an outlet of the cooling system thereby allowing the water within the water lines to recirculate thereby increasing the temperature of the water to the defined temperature.

18. The method of claim 16, wherein the method further comprises executing the cooling program in response to the temperature of the water circulating within the water lines being hotter than the defined temperature, wherein the cooling program comprises directing a flow control valve of the cooling system to fully open and a recirculating pump of the cooling system to stop operation in order to allow the water to leave the cooling system via an outlet of the cooling system and new water from a water pump to enter via an inlet of the cooling system decreasing the temperature of the water to the defined temperature

19. The method of claim 16, wherein the method further comprises executing the maintenance program in response to the temperature of the water being at the defined temperature, wherein the maintenance program comprises directing a flow control valve of the cooling system to partially close in order to allow the water to gradually leave the cooling system via an outlet of the cooling system and new water from a water pump of the cooling system to gradually enter via an inlet of the cooling system.

20. The method of claim 15, wherein the defined temperature is set by an operator of the cooling system.
